(19) United States
(12) Patent Application Publication
(10) Pub. No.: US 2011/0123086 A1
(43) Pub. Date: May 26, 2011

(54) SYSTEMS AND METHODS FOR ENHANCING MEDICAL IMAGES

(75) Inventors: Yao Nie, Sunnyvale, CA (US); Chao Shi, San Jose, CA (US); Nariman Majdi-Nasab, San Jose, CA (US); Akira Hasegawa, Saratoga, CA (US)

(73) Assignee: FUJIFILM CORPORATION, Tokyo (JP)

(21) Appl. No.: 12/626,597

(22) Filed: Nov. 25, 2009

(51) Int. Cl. G06K 9/00

(52) U.S. Cl. 382/132

(57) ABSTRACT

A system and method is provided for enhancing a region of interest in a medical image to improve its visibility. A region of interest is first identified in the medical image, such as identifying a breast region in a mammography image. The identified region of interest is then enhanced using an image processing technique, for example by adjusting the intensity or contrast, or by performing edge enhancement. Other regions of the medical image outside the region of interest remain unaltered, or may be diminished, such that the clarity of the region of interest is improved in comparison with the other regions of the medical image. A user viewing the enhanced image is less distracted by the non-enhanced regions and is not required to adjust the image on his or her own. The user can more quickly and effectively review the medical image to identify abnormalities and diagnose disease.

### BACKGROUND

1. Field

The systems and methods described below relate to enhancing medical images, and more specifically to enhancing a region of interest to increase its visibility in a medical image such as a mammography image.

2. Background

Medical imaging is the field of creating images of the human body for medical purposes, such as diagnosing or examining disease or other physiological anomalies. Numerous types of image modalities produce medical images, such as magnetic resonance imaging (MRI), radiography (x-rays), computed tomography (CT), ultrasound (US) and others. In medical imaging, an object of interest is usually selected pertaining to an area of the human body, such as the head, heart or chest.

One type of medical imaging is mammography, which is the examination of a medical image of the human breast. Mammography is used to detect breast cancer by examining the breast tissue for abnormalities such as microcalcifications or uncharacteristic masses.

In the process of reading digital mammography images, a user, such as a radiologist, often needs to enhance the image to make a region of interest more prominent. Such image adjustments include brightness adjustment, contrast adjustment, image inversion, etc. When an adjustment is applied to the whole image, the background may also be adjusted, which counters the effect of enhancing the region of interest, such as a breast region. For example, FIG. 1A illustrates a mammography image 100 where a breast implant 102 presents in the image. The brightness of the implant 102 may dominate the image 100, thus obscuring surrounding tissue 104 that is of interest. To try and improve the clarity of the image, a radiologist may perform an image inversion by inverting the intensity to make the implant 102 appear darker in the image 100, as depicted in FIG. 1B. However, the image inversion also makes a background region 106 brighter, which may prevent the radiologist from accurately reading the breast tissue 104. Further, any type of image adjustment is time consuming and tedious, thus discouraging the radiologist from attempting to obtain the clearest possible image with the best chance of diagnosing any potential abnormalities.

Thus, it is desired to develop systems and methods for enhancing a medical image such that only a relevant region of interest is enhanced.

### SUMMARY

Various embodiments of the invention relate to systems and methods for enhancing a medical image, and more specifically to enhancing a region of interest in a medical image such as a mammography image. At least one region of interest in a medical image is identified, after which the region of interest is enhanced while the remaining regions of the medical image remain unaltered. The medical image with the enhanced region of interest is then displayed to a user.

One aspect of certain embodiments of the invention relates to a method for enhancing a medical image, comprising identifying at least one region of interest in a medical image; enhancing the at least one region of interest; and displaying the medical image with the enhanced region of interest on a display.

In another embodiment of the invention, the region of interest is automatically identified.

In another embodiment of the invention, the region of interest is automatically identified using a border detection algorithm.

In another embodiment of the invention, the region of interest is human tissue.

In another embodiment of the invention, the region of interest is a breast region.

In another embodiment of the invention, the region of interest is an anatomical region of the breast region which is a portion of the breast region.

In another embodiment of the invention, the region of interest is selected by a user.

In another embodiment of the invention, the user determines the amount of enhancement to apply to the at least one region of interest.

In another embodiment of the invention, the region of interest is enhanced using an image processing technique.

In another embodiment of the invention, the image processing technique includes at least one of intensity adjustment, contrast adjustment, intensity inversion and edge enhancement.

In another embodiment of the invention, an area of the medical image outside of the region of interest is diminished using an image processing technique.

Embodiments of the invention also relate to a system for enhancing a medical image, comprising an identifying unit which identifies at least one region of interest in the medical image; an enhancement unit which enhances the at least one region of interest; and a display unit which displays the medical image with the enhanced region of interest on a display.

In another embodiment of the invention, the system further comprises a display unit which displays the medical image with the enhanced region of interest on a display.

In another embodiment of the invention, the region of interest is identified automatically.

In another embodiment of the invention, the region of interest is identified automatically using a border detection algorithm.

In another embodiment of the invention, the region of interest is human tissue.

In another embodiment of the invention, the region of interest is a breast region.

In another embodiment of the invention, the region of interest is an anatomical region of the breast region.

In another embodiment of the invention, the region of interest is selected by a user.

In another embodiment of the invention, the user determines the amount of enhancement to apply to the at least one region of interest.

In another embodiment of the invention, the region of interest is enhanced using an image processing technique.

In another embodiment of the invention, the image processing technique includes at least one of intensity adjustment, contrast adjustment, intensity inversion and edge enhancement.

In another embodiment of the invention, an area of the medical image outside of the region of interest is diminished using an image processing technique.

Embodiments of the invention also relate to a computer program product for enhancing a medical image, the computer program product embodied on a computer readable medium and when executed by a computer, performs the method comprising: identifying at least one region of interest in a medical image; automatically enhancing the at least one region of interest; and displaying the medical image with the enhanced region of interest on a display

Additional embodiments related to the invention will be set forth in part in the description which follows, and in part will be apparent from the description, or may be learned by practice of the invention. Embodiments of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify various embodiments of the present invention and, together with the description, serve to explain and illustrate principles of the inventive technique. Specifically:

FIG. 1A depicts an unaltered mammography image showing a breast with an implant, as is known in the art;

FIG. 1B depicts an altered mammography image where the intensity has been inverted, as is known in the art;

FIG. 2A depicts an unaltered mammography image, as is known in the art;

FIG. 2B depicts a mammography image where an increase in intensity has been applied to the entire image, as is known in the art;

FIG. 2C depicts a mammography image where an increase in intensity has been applied to a region of interest corresponding to a breast region, according to one embodiment of the invention;

FIG. 3A depicts a mammography image where a background region has not been altered, as is known in the art;

FIG. 3B depicts a mammography image where the background region has been altered to an intensity of zero, according to one embodiment of the invention;

FIGS. 4A-4C depict methods of enhancing a region of interest in a medical image, according to various embodiments of the invention;

FIG. 5 illustrates a system for enhancing a region of interest in a medical image, according to one embodiment of the invention; and

FIG. 6 illustrates an exemplary embodiment of a computer platform upon which the inventive system may be implemented.

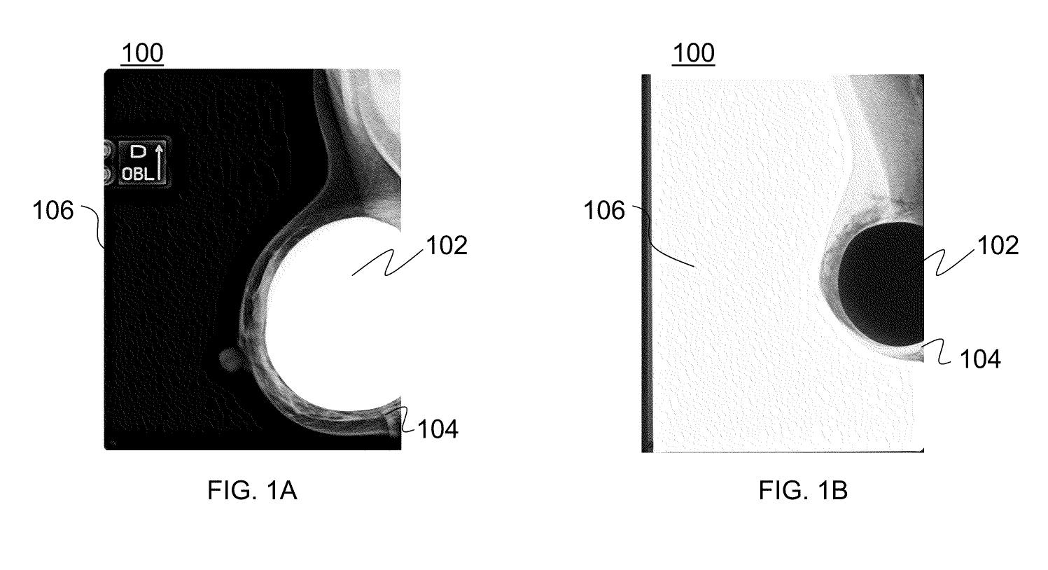

### DETAILED DESCRIPTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

Various embodiments of the invention relate to systems and methods for enhancing a medical image, and more specifically to enhancing a region of interest in a medical image such as a mammography image. At least one region of interest in a medical image is identified, after which the region of interest is enhanced while the remaining regions of the image are unaltered. The medical image with the enhanced region of interest is then displayed to a user.

By identifying and enhancing a region of interest, the systems and methods described herein aid a user in reviewing the medical images by saving the user significant time and effort that would otherwise be spent altering the image manually. The overall work flow of medical image screening and diagnosis will be improved. Additionally, the systems and methods described herein are capable of enhancing only a region of interest as opposed to the entire image, thereby preventing the other non-relevant regions of the image, such as the background, from distracting the user. The user viewing the medical image, for example a radiologist, can more clearly view and more accurately identify any potential physiological abnormalities without being distracted by enhancements to non-relevant regions.

The inventive systems and methods are applicable to many types of medical imaging, including but not limited to magnetic resonance imaging (MRI), radiography (x-rays), computed tomography (CT) and ultrasound (US).

The following illustrative embodiments pertain to mammography images, but one skilled in the art will appreciate that the methods and systems described herein can be applied to any medical image of any area of the body with a region of interest to a user. In any medical image, the inventive systems and methods allow the user to identify a region of interest and enhance the region of interest while leaving the remainder of the image unaltered.

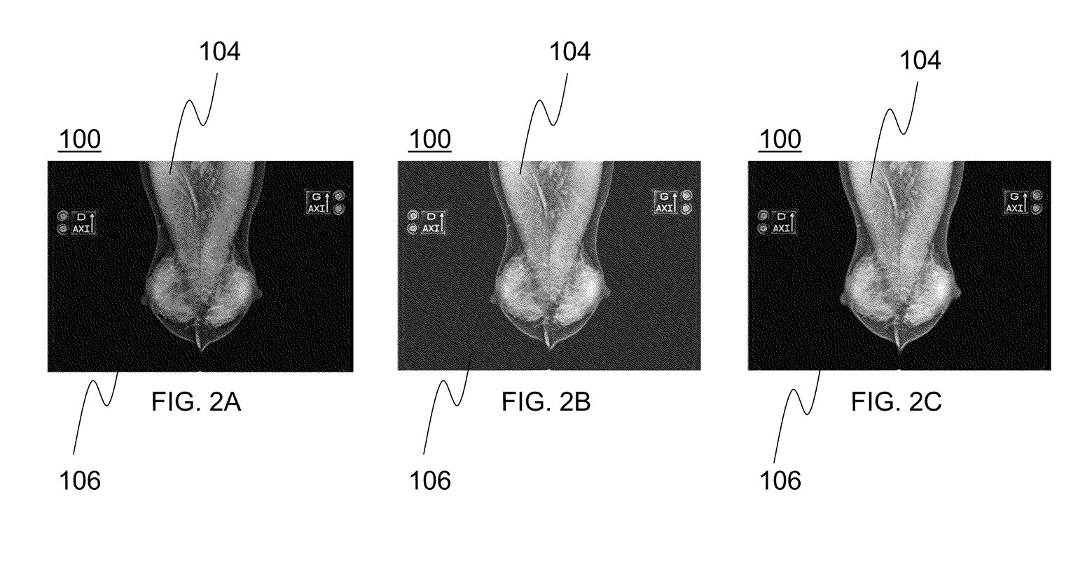

In one embodiment, identification of a region of interest in a medical image can be accomplished using a breast border detection algorithm performed automatically by a computer. An exemplary breast border detection algorithm is disclosed in “Automatic detection of the breast border and nipple position on digital mammograms using genetic algorithm for asymmetry approach to detection of microcalcifications,” Computer Methods and Programs in Biomedicine, Volume 87, Issue 1 (July 2007), Pages 12-20, incorporated herein in its entirety by reference. In FIG. 2A, the breast border detection algorithm will identify a region of interest in the mammography image 100 as a breast region 104, surrounded by the background region 106.

It will be appreciated by one of skill in the art, however, that the region of interest is not confined to a breast region. Any anatomical region of the breast may be identified as the region of interest. For example, a portion of the breast which is adjacent to the pectoral muscle and known as the “milky way;” any of the anatomical four quadrants of the breast—upper-outer, upper-inner, lower-outer, lower-inner; or any of the anatomical zones—sub-areolar, anterior, middle or posterior region, can be identified as the region of interest. To identify these anatomical regions, the breast border, pectoral muscle and the nipple location are first detected, as described above. These anatomical features can be readily identified by a computer algorithm described above with regard to breast border and nipple position detection. For example, the outer and inner regions of a breast area are identified in a cranial-caudal (CC) view mammography image by using a line segment that passes through a nipple and divides the breast into two equally-sized regions. An exemplary method for nipple and pectoral muscle detection is disclosed in “Radon-domain detection of the nipple and the pectoral muscle in mammograms”, J Digit Imaging, 2008 March; 21(1): 37-49. Epub 2007 Apr. 11, incorporated by reference herein in its entirety.

In addition, the identification of a region of interest can also be applied to medical images other than a mammography image, in order to define regions of interest corresponding to other anatomical features or areas of the body. For example, medical images of humans or animals, including the brain, abdomen, arms or legs will all include at least a background image that will not need enhancement, while including at least some portion of human or animal tissue that will benefit from enhancement. Further, a user may define an arbitrary region of interest for enhancement, for example by creating a window around the region of interest, selecting a predefined region of interest from a menu of commonly-used regions of interest, or tracing the region of interest using an input device on a computer.

In FIG. 2B, a known method of enhancing a medical image is depicted, where the entire mammography image 100 is enhanced, including the breast region 104 and background region 106. As seen in FIG. 2B, the effectiveness of the enhancement to the breast region 104 is reduced by the enhancement to the background region 106. As the entire image 100 has been enhanced, the enhancements to the background region 106 are distracting to a user trying to focus on the breast region 104.

FIG. 2C depicts a mammography image 100 where only the identified region of interest—the breast region 104—has been enhanced. In this particular embodiment, the intensity of the breast region 104 has been increased from the original image in FIG. 2A. As is evident by viewing the image 100, the breast region 104 appears much more clear and prominent in comparison to the unenhanced background region 106.

In one embodiment, the enhancements to the region of interest are accomplished through an image processing technique carried out by a computer. Image processing may include, for example, increasing or decreasing the brightness; contrast enhancement; edge enhancement; or intensity inversion. The contrast of the image can be enhanced using a histogram equalization technique, which transforms the values in an intensity image so that the histogram of the output image approximately matches a uniform distribution. The brightness of the image can be increased/decreased by increasing/decreasing the intensity value of each pixel in the image by a certain amount or certain ratio. The edge enhancement can be performed by first detecting the edges in the image using an edge detection filter, such as Sobel filter, which is known in the art and therefore not further explained here. The detected edges are represented by an edge image. The intensities of the edge image are then multiplied by a factor larger than 1. Finally, the multiplied edge image is added to the original image pixel by pixel, which generates the edge enhanced image. Intensity inversion can be performed by subtracting the image intensity value from the maximal intensity value, so that the highest intensity value becomes the lowest, and vice versa. The amount of the enhancement needed varies according to the user's preference. The user can use a computer input device to adjust the amount of enhancement until the resulting image has the desired appearance. Or, the amount of enhancement can be decided automatically using a default parameter setting. For example, the brightness of the image can be adjusted such that the center of the intensity histogram is the middle value that can be represented by a computer data.

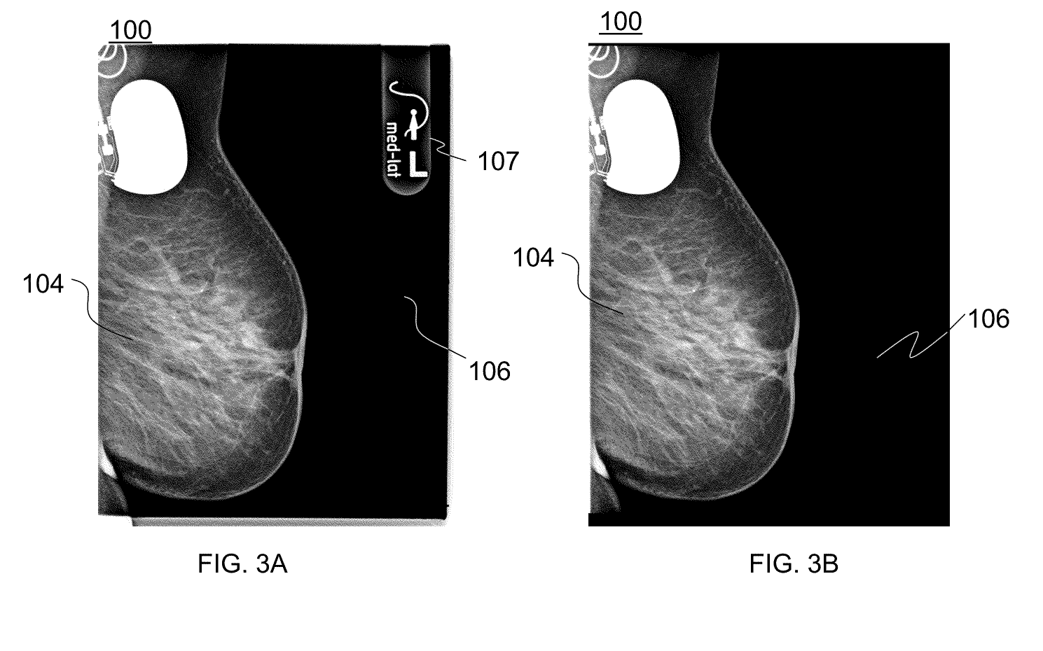

In another embodiment, the background region 106 may be diminished by setting the intensity value to a constant value, e.g. zero. FIG. 3A depicts a mammography image 100 with a background 106 that has not been altered or enhanced. In comparison, FIG. 3B depicts a mammography image 100 where the intensity value of the background 106 has been set to zero. The lead marker 107 that was visible in the background no longer appears.

In a further embodiment, the user may interactively enhance the region of interest by enhancing the image by an amount desired by the user. In this way, the region of interest can be enhanced to achieve the user's preferred level.

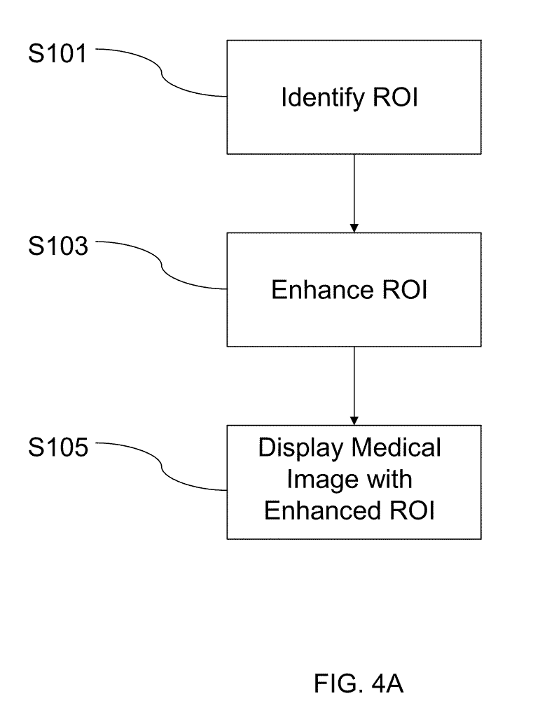

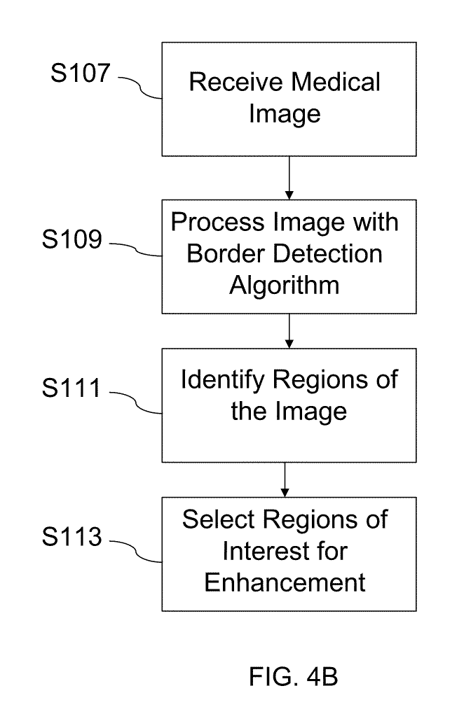

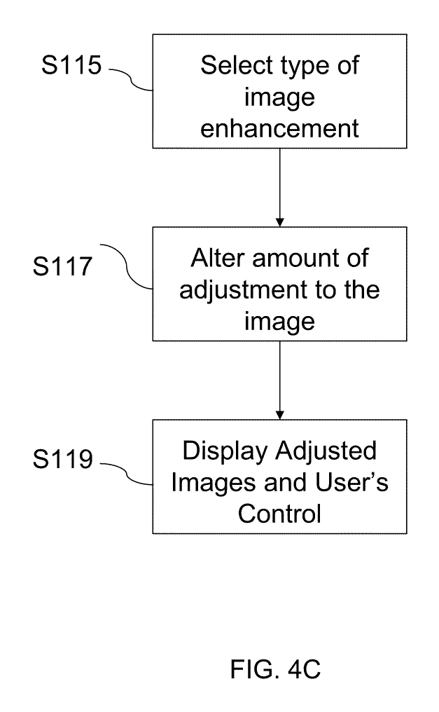

FIG. 4A depicts a method for enhancing a region of interest, according to one embodiment of the invention. In a first step S101, at least one region of interest in a medical image is identified. In a second step S103, the at least one region of interest is enhanced while other regions of the image are not enhanced. Finally, in step S105, the medical image with the enhanced region of interest is displayed.

FIG. 4B depicts one embodiment of more detailed steps of a method of identifying a region of interest, including a first step S107 of receiving a medical image at an image processor such as a computer. The medical image may be received directly from a medical imaging device such as an MRI, or the medical images could be stored after creation and inputted to a computer for processing at a later date. In a second step S109, the medical image is processed with a breast border detection algorithm as referenced above, which detects a border of a breast region. In a next step S111, the identified borders are used to identify regions in the image, such as a breast region and a background region. Finally, in a fourth step S113, one of the regions is selected as a region of interest, either automatically or manually by a user.

FIG. 4C depicts one embodiment of more detailed steps of a method for enhancing a region of interest. In a first step S115, the user selects the type of image adjustment to perform, using a computer input device. For example, the user can select contrast adjustment by clicking the contrast icon on the computer display using a mouse. Then, in step S117, the user can control the amount of the adjustment through similar input devices, such as moving a mouse along the scroll bar. The image after the adjustment is displayed instantly along with the user's control in step S119. Thus, the user can change the amount of adjustment until the desired visual result appears.

The amount of the adjustment can also be automatically determined such that no user interaction is needed. As an example, when histogram equalization is used for contrast enhancement, each pixel intensity value is mapped to a new value using a linear function such that the width of the histogram is increased. The contrast enhancement can be set to the maximal level by default, such that the lowest (highest) intensity in the image is mapped to the minimal (maximal) value that can be represented by the computer. The detailed steps are: 1) find the highest and the lowest intensity values in the region of interest, which are X_high and X_low, respectively; 2) Select the highest and the lowest intensity value in the target (enhanced) image, Y_high and Y_low, respectively; where Y_high>X_high, and Y_low<X_low. For maximal enhancement, set Y_high=Maximal, Y_low=Mininal, wherer Maximal and Minimal are the maximal and the minimal value that can be represented by the computer; 3) The target pixel value Y=(X−X_low)*(Y_high−Y_low)/(X_high−X_low)+Y_low, where X is the original pixel value.

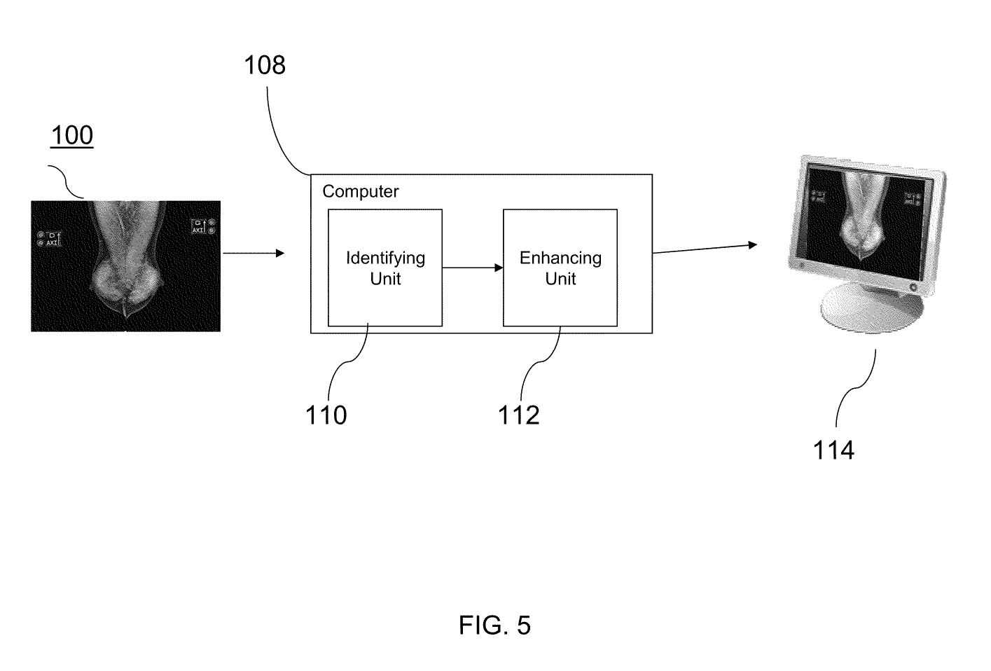

The inventive system may be implemented on a computer which receives the medical image and processes it according to the steps described above. The inventive system may be embodied as a computer program product or carried out by a combination of software and hardware. As illustrated in FIG. 5, an image 100 may be input to the computer 108 where an identifying unit 110 identifies the at least one region of interest in the medical image. An enhancement unit 112 then enhances the at least one region of interest while other regions of interest are not enhanced. Finally, a display unit 114 displays the medical image with the enhanced region of interest on a display for viewing by the user. In one non-limiting embodiment, the system provides the enhanced medical image as an option to the user, so that the user can compare the enhanced medical image to the original unaltered image.

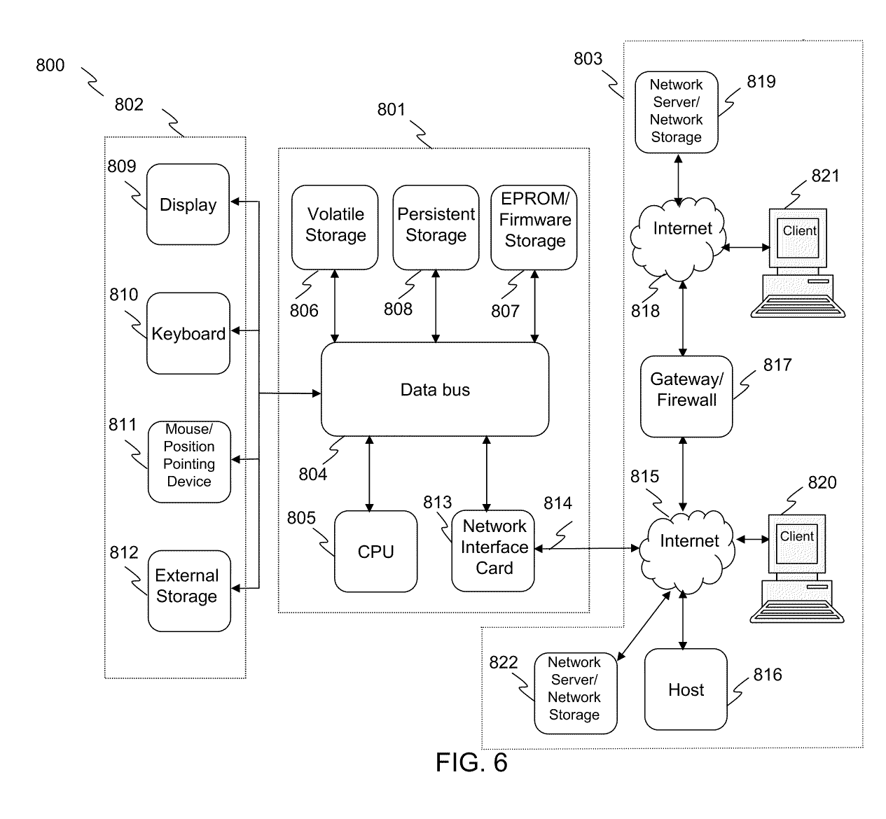

FIG. 6 is a block diagram that illustrates an embodiment of a computer/server system 800 upon which an embodiment of the inventive methodology may be implemented. The system 800 includes a computer/server platform 801, peripheral devices 802 and network resources 803.

The computer platform 801 may include a data bus 804 or other communication mechanism for communicating information across and among various parts of the computer platform 801, and a processor 805 coupled with bus 801 for processing information and performing other computational and control tasks. Computer platform 801 also includes a volatile storage 806, such as a random access memory (RAM) or other dynamic storage device, coupled to bus 804 for storing various information as well as instructions to be executed by processor 805. The volatile storage 806 also may be used for storing temporary variables or other intermediate information during execution of instructions by processor 805. Computer platform 801 may further include a read only memory (ROM or EPROM) 807 or other static storage device coupled to bus 804 for storing static information and instructions for processor 805, such as basic input-output system (BIOS), as well as various system configuration parameters. A persistent storage device 808, such as a magnetic disk, optical disk, or solid-state flash memory device is provided and coupled to bus 801 for storing information and instructions.

Computer platform 801 may be coupled via bus 804 to a display 809, such as a cathode ray tube (CRT), plasma display, or a liquid crystal display (LCD), for displaying information to a system administrator or user of the computer platform 801. An input device 820, including alphanumeric and other keys, is coupled to bus 801 for communicating information and command selections to processor 805. Another type of user input device is cursor control device 811, such as a mouse, a trackball, or cursor direction keys for communicating direction information and command selections to processor 804 and for controlling cursor movement on display 809. This input device typically has two degrees of freedom in two axes, a first axis (e.g., x) and a second axis (e.g., y), that allows the device to specify positions in a plane.

An external storage device 812 may be connected to the computer platform 801 via bus 804 to provide an extra or removable storage capacity for the computer platform 801. In an embodiment of the computer system 800, the external removable storage device 812 may be used to facilitate exchange of data with other computer systems.

The invention is related to the use of computer system 800 for implementing the techniques described herein. In an embodiment, the inventive system may reside on a machine such as computer platform 801. According to one embodiment of the invention, the techniques described herein are performed by computer system 800 in response to processor 805 executing one or more sequences of one or more instructions contained in the volatile memory 806. Such instructions may be read into volatile memory 806 from another computer-readable medium, such as persistent storage device 808. Execution of the sequences of instructions contained in the volatile memory 806 causes processor 805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 805 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 808. Volatile media includes dynamic memory, such as volatile storage 806. Transmission media includes coaxial cables, copper wire and fiber optics, including the wires that comprise data bus 804. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 805 for execution. For example, the instructions may initially be carried on a magnetic disk from a remote computer. Alternatively, a remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on the data bus 804. The bus 804 carries the data to the volatile storage 806, from which processor 805 retrieves and executes the instructions. The instructions received by the volatile memory 806 may optionally be stored on persistent storage device 808 either before or after execution by processor 805. The instructions may also be downloaded into the computer platform 801 via Internet using a variety of network data communication protocols well known in the art.

The computer platform 801 also includes a communication interface, such as network interface card 813 coupled to the data bus 804. Communication interface 813 provides a two-way data communication coupling to a network link 814 that is connected to a local network 815. For example, communication interface 813 may be an integrated services digital network (ISDN) card or a modem to provide a data communication connection to a corresponding type of telephone line. As another example, communication interface 813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 813 sends and receives electrical, electromagnetic or optical signals that carry digital data streams representing various types of information.

Network link 813 typically provides data communication through one or more networks to other network resources. For example, network link 814 may provide a connection through local network 815 to a host computer 816, or a network storage/server 817. Additionally or alternatively, the network link 813 may connect through gateway/firewall 817 to the wide-area or global network 818, such as an Internet. Thus, the computer platform 801 can access network resources located anywhere on the Internet 818, such as a remote network storage/server 819. On the other hand, the computer platform 801 may also be accessed by clients located anywhere on the local area network 815 and/or the Internet 818. The network clients 820 and 821 may themselves be implemented based on the computer platform similar to the platform 801.

Local network 815 and the Internet 818 both use electrical, electromagnetic or optical signals that carry digital data streams. The signals through the various networks and the signals on network link 814 and through communication interface 813, which carry the digital data to and from computer platform 801, are exemplary forms of carrier waves transporting the information.

Computer platform 801 can send messages and receive data, including program code, through the variety of network(s) including Internet 818 and LAN 815, network link 814 and communication interface 813. In the Internet example, when the system 801 acts as a network server, it might transmit a requested code or data for an application program running on client(s) 820 and/or 821 through Internet 818, gateway/firewall 817, local area network 815 and communication interface 813. Similarly, it may receive code from other network resources.

The received code may be executed by processor 805 as it is received, and/or stored in persistent or volatile storage devices 808 and 806, respectively, or other non-volatile storage for later execution. In this manner, computer system 801 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the invention. For example, the described software may be implemented in a wide variety of programming or scripting languages, such as Assembler, C/C++, perl, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in the computerized storage system. It is intended that all matter contained in the above description or shown in the accompanying drawings shall be interpreted as illustrative only and not limiting.

What is claimed is:

1. A method for enhancing a medical image, the method comprising:
identifying at least one region of interest in a medical image;
automatically enhancing the at least one region of interest; and
displaying the medical image with the enhanced region of interest on a display.

2. The method of claim 1, wherein the region of interest is automatically identified.

3. The method of claim 2, wherein the region of interest is automatically identified using a border detection algorithm.

4. The method of claim 3, wherein the region of interest is human tissue.

5. The method of claim 4, wherein the region of interest is a breast region.

6. The method of claim 5, wherein the region of interest is an anatomical region of the breast region which is a portion of the breast region.

7. The method of claim 1, wherein the region of interest is selected by a user.

8. The method of claim 1, wherein the user determines the amount of enhancement to apply to the at least one region of interest.

9. The method of claim 1, wherein the region of interest is enhanced using an image processing technique.

10. The method of claim 9, wherein the image processing technique includes at least one of intensity adjustment, contrast adjustment, intensity inversion and edge enhancement.

11. The method of claim 9, wherein an area of the medical image outside of the region of interest is diminished using an image processing technique.

12. A system for enhancing a medical image, the system comprising:
an identifying unit which identifies at least one region of interest in a medical image; and
an enhancing unit which enhances the at least one region of interest.

13. The system of claim 12, further comprising a display unit which displays the medical image with the enhanced region of interest on a display.

14. The system of claim 12, wherein the region of interest is identified automatically.

15. The system of claim 14, wherein the region of interest is identified automatically using a border detection algorithm.

16. The system of claim 15, wherein the region of interest is human tissue.

17. The system of claim 16, wherein the region of interest is a breast region.

18. The system of claim 17, wherein the region of interest is an anatomical region of the breast region.

19. The system of claim 12, wherein the region of interest is selected by a user.

20. The system of claim 12, wherein the user determines the amount of enhancement to apply to the at least one region of interest

21. The system of claim 12, wherein the region of interest is enhanced using an image processing technique.

22. The system of claim 21, wherein the image processing technique includes at least one of intensity adjustment, contrast adjustment, intensity inversion and edge enhancement.

23. The system of claim 21, wherein an area of the medical image outside of the region of interest is diminished using an image processing technique.

24. A computer program product for enhancing a medical image, the computer program product embodied on a computer readable medium and when executed by a computer, performs the method comprising:
identifying at least one region of interest in a medical image;
automatically enhancing the at least one region of interest; and
displaying the medical image with the enhanced region of interest on a display.
